(19) United States
(12) Patent Application Publication
(10) Pub. No.: US 2013/0290730 A1
(43) Pub. Date: Oct. 31, 2013

(54) SYSTEMS AND METHODS FOR DATA ACCESS PROTECTION

(71) Applicants: Richard James SOMERFIELD, Cheshire (GB); Paul Keith BRANTON, Rochdale (GB)

(72) Inventors: Richard James SOMERFIELD, Cheshire (GB); Paul Keith BRANTON, Rochdale (GB)

(73) Assignee: AppSense Limited, Warrington (GB)

(21) Appl. No.: 13/456,396

(22) Filed: Apr. 26, 2012

(51) Int. Cl. H04L 9/28

(52) U.S. Cl. 713/189

(57) ABSTRACT

Systems and methods are provided for data access protection. The disclosed computing system can provide an adjusted iteration count to a dynamic key stretching module. The computer system can determine whether the adjusted iteration count is to be used to enhance a passphrase for data encryption or data decryption. When the adjusted iteration count is to be used for data encryption, the computing system is configured to compute the adjusted iteration count by modifying a base iteration count according to an adjustment configuration; when the adjusted iteration count is to be used for data decryption, the computing system is configured to retrieve the adjusted iteration count that was used to encrypt the data. Once the adjusted iteration count is determined, the computing system is configured to provide the adjusted iteration count to the dynamic key stretching module.

### CROSS-REFERENCE TO RELATED APPLICATION

This application is related to a co-pending U.S. Pat. No. ______, entitled “SYSTEMS AND METHODS FOR DATA ACCESS PROTECTION,” filed on even date herewith, which is expressly hereby incorporated by reference herein in its entirety.

### BACKGROUND

1. Technical Field

Disclosed systems and methods relate to data access protection in a computing system.

2. Description of the Related Art

Data security is an important problem in modern computing systems, especially with the advent of cloud computing. Traditionally, computing systems protected data against unauthorized access by associating the data with a password or a passphrase. In a passphrase protected computing system, unless the system receives the correct passphrase, the computing system does not grant access to the data.

In the past, the passphrase based data protection worked reasonably well because it was challenging for an unauthorized party to determine the correct passphrase. To an unauthorized party, guessing the correct passphrase from all possible passphrases was not an easy task. Furthermore, trying every candidate passphrase until the computing system grants data access required too much computation, and thus, computing time. As the computing technology advanced, however, the speed of computing systems improved drastically. The improved computing systems provided an unauthorized party the ability to try every candidate passphrase in a reasonable amount of time. Therefore, there is a need in the art to provide systems and methods for improving passphrase based data protection.

Accordingly, it is desirable to provide methods and systems that overcome these and other deficiencies of the related art.

### SUMMARY

In accordance with the disclosed subject matter, systems and methods are provided for data access protection in a computing system.

Disclosed subject matter includes a non-transitory computer readable medium having executable instructions.

Disclosed subject matter includes an apparatus having a processor configured to run a module stored in memory. The module can be configured to receive an iteration count determination request from a dynamic key stretching module to provide an adjusted iteration count to the dynamic key stretching module. The module can be further configured to determine whether the requested adjusted iteration count is to be used to enhance a passphrase for data encryption or data decryption. When the adjusted iteration count is to be used to enhance the passphrase for data encryption, the module is configured to compute the adjusted iteration count by modifying a base iteration count according to an adjustment configuration. In contrast, when the adjusted iteration count is to be used to enhance the passphrase for data decryption, the module is configured to retrieve, from a non-transient storage medium, the adjusted iteration count that was used to encrypt the data. Then the module can provide the adjusted iteration count to the dynamic key stretching module.

In one embodiment, the processor in the apparatus can be further configured to run the dynamic key stretching module stored in the memory. The dynamic key stretching module can be configured to receive the adjusted iteration count and to operate a hash function on the passphrase by the adjusted iteration count to compute an enhanced passphrase associated with the passphrase.

In another embodiment, the processor in the apparatus can be further configured to run an encryption module stored in the memory. The encryption module can be configured to encrypt a file using the enhanced passphrase and to store the encrypted file in a non-transitory storage medium, where the encrypted file's header includes the adjusted iteration count.

In some embodiments, the iteration count determination request can indicate whether the adjusted iteration count is to be used for data encryption or data decryption.

In other embodiments, the adjustment configuration can indicate that the base iteration count be modified by a random number. In some aspects, the random number is significantly smaller than the base iteration count.

In some embodiments, the adjustment configuration can indicate that the base iteration count be modified by a function of time. In some aspects, the function of time is an exponential function of time. In other aspects, the function of time is a linear function of time.

In some embodiments, the apparatus can further include one or more interfaces configured to provide communication with a server via a communication network. The dynamic key stretching module can be configured to run on the server, and the module can be further configured to provide the adjusted iteration count to the dynamic stretching module using the one or more interfaces via the communication network. In some aspects, the module can be further configured to receive the iteration count determination request from the dynamic key stretching module on the server via the communication network.

In other embodiments, the module can be configured to update the base iteration count upon receiving a reset request.

Disclosed subject matter includes a method. The method can include receiving, from a dynamic key stretching module, an iteration count determination request, requesting the module to provide an adjusted iteration count to the dynamic key stretching module. The method can further include determining whether the adjusted iteration count is to be used to enhance a passphrase for data encryption or data decryption. When the adjusted iteration count is to be used to enhance the passphrase for data encryption, the method can proceed by computing the adjusted iteration count by modifying a base iteration count according to an adjustment configuration. When the adjusted iteration count is to be used to enhance the passphrase for data decryption, the method can proceed by retrieving, from a non-transient storage medium, the adjusted iteration count that was used to encrypt the data. The method can further include providing the adjusted iteration count to the dynamic key stretching module.

In some embodiments, the method can further include receiving the adjusted iteration count and operating a hash function on the passphrase by the adjusted iteration count to compute an enhanced passphrase associated with the passphrase. The method can further include encrypting a file using the enhanced passphrase, and storing the encrypted file in a non-tangible storage medium, where the encrypted file's header includes the adjusted iteration count.

In one embodiment, the adjustment configuration can indicate that the base iteration count be modified by a random number. In another embodiment, the adjustment configuration can further indicate that the base iteration count be modified by a function of time.

Disclosed subject matter includes a non-transitory computer readable medium having executable instructions. The executable instructions are operable to cause an apparatus to receive, from a dynamic key stretching module, an iteration count determination request, requesting the module to provide an adjusted iteration count to the dynamic key stretching module and to determine whether the adjusted iteration count is to be used to enhance a passphrase for data encryption or data decryption. When the adjusted iteration count is to be used to enhance the passphrase for data encryption, the executable instructions are then operable to cause the apparatus to compute the adjusted iteration count by modifying the base iteration count according to an adjustment configuration. When the adjusted iteration count is to be used to enhance the passphrase for data decryption, the executable instructions are then operable to cause the apparatus to retrieve, from a non-transient storage medium, the adjusted iteration count that was used to encrypt the data, and to provide the adjusted iteration count to the dynamic key stretching module.

In some embodiments, the adjustment configuration indicates that the base iteration count be modified by a random number. In other embodiments, the adjustment configuration indicates that the base iteration count be modified by a function of time. In one aspect, the function of time can be an exponential function of time.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates a diagram of a networked communication system in accordance with certain embodiments of the disclosed subject matter.

FIGS. 2A-2C illustrate passphrase enhancement methods in accordance with certain embodiments of the disclosed subject matter.

FIG. 3 illustrates dynamic key stretching in accordance with certain embodiments of the disclosed subject matter.

FIGS. 4A-4B illustrate how an encryption module and a decryption module use dynamic key stretching in accordance with certain embodiments of the disclosed subject matter.

FIG. 5 illustrates offloaded key stretching in accordance with certain embodiments of the disclosed subject matter.

FIG. 6 illustrates a block diagram of a computing system in accordance with certain embodiments of the disclosed subject matter.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

The disclosed subject matter relates to systems and methods for data access protection. Protecting access to data is an important problem in modern computing systems because data can be easily reached via communication networks. Unless data access is adequately controlled, confidential data could be leaked in a matter of seconds.

Oftentimes, computer systems protect data access using an encryption mechanism. An encryption mechanism encrypts data with an encryption key so that the encrypted data cannot be retrieved or accessed without a decryption key. If the encryption mechanism is asymmetric, the encryption key is distinct from the decryption key; if the encryption mechanism is symmetric, the encryption key is identical to the decryption key. In some embodiments, the encryption mechanism can be implemented using an encryption module and a decryption module. The encryption module is configured to encrypt a file using an encryption key, and the decryption module is configured to decrypt an encrypted file using a decryption key.

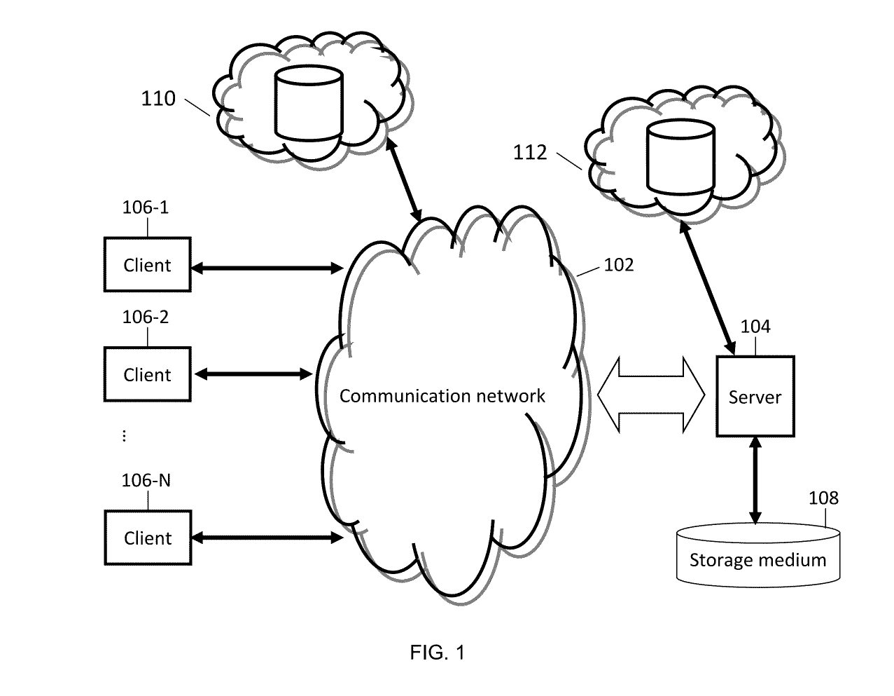

The encryption module and the decryption module can be implemented in a computing system. FIG. 1 illustrates a computing system for implementing the encryption mechanism in accordance with certain embodiments. FIG. 1 includes a communication network 102, a server 104, at least one client 106 (e.g., client 106-1, . . . , 106-N,) a physical storage medium 108, and a cloud storage 110 and 112.

Each client 106 can communicate with the server 104 to send data to, and to receive data from, the server 104 across the communication network 102. Although FIG. 1 shows each client 106 being directly coupled to the server 104, each client 106 can be connected to server 104 via any other suitable device, communication network, or combination thereof. For example, each client 106 can be coupled to the server 104 via one or more routers, switches, access points, and/or communication network (as described below in connection with communication network 102). A client 106 can include a desktop computer, a mobile computer, a tablet computer, a cellular device, or any computing systems that are capable of performing computation.

Server 104 is coupled to at least one physical storage medium 108, which is configured to store data for the server 104. Any client 106 can store data in, and access data from, the physical storage medium 108 via the server 104. FIG. 1 shows the server 104 and the physical storage medium 108 as separate components; however, the server 104 and physical storage medium 108 can be combined together. FIG. 1 also shows the server 104 as a single server; however, server 104 can include more than one server. FIG. 1 shows the physical storage medium 108 as a single physical storage medium; however, physical storage medium 108 can include more than one physical storage medium. The physical storage medium 108 can be located in the same physical location as the server 104, at a remote location, or any other suitable location or combination of locations.

FIG. 1 shows two embodiments of a cloud storage 110 and 112. Cloud storage 110 and/or 112 can store data from physical storage medium 108 with the same restrictions, security measures, authentication measures, policies, and other features associated with the physical storage medium 108. FIG. 1 shows the cloud storage 112 separate from the communication network 102; however, cloud storage 112 can be part of communication network 102 or another communication network. The server 104 can use only cloud storage 110, only cloud storage 112, or both cloud storages 110 and 112. FIG. 1 shows one cloud storage 110 and one cloud storage 112; however, more than one cloud storage 110, more than one cloud storage 112 or any suitable combination thereof can be used.

The communication network 102 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. FIG. 1 shows the network 102 as a single network; however, the network 102 can include multiple interconnected networks listed above.

In some embodiments, the encryption mechanism can be implemented in the client 106 or the server 104 in an independent manner. For example, a client 106 can include both an encryption module and a decryption module, and the client 106 can locally perform the encryption and decryption of files. In other embodiments, the encryption mechanism can be implemented in a distributed manner. For example, a client 106 can encrypt data using its encryption module, and a server 104 can decrypt the encrypted data using its decryption module. In certain embodiments, the encryption mechanism can be implemented in a centralized manner at a server 104. For example, a client 106 can provide an encryption key or a decryption key to the server 104, and the server 104 uses its encryption or decryption module and the received encryption key or the decryption key to encrypt or decrypt the file.

One of the popular encryption mechanisms is based on passphrases. A passphrase based encryption mechanism is a symmetric encryption mechanism that uses a passphrase as both the encryption key and the decryption key. A file can be encrypted using a passphrase, and the encrypted file can be decrypted using the same passphrase. This way, the file can only be decrypted by a party with the correct passphrase.

In the past, the passphrase based encryption mechanism worked reasonably well because identifying the correct passphrase within a reasonable period of time was extremely challenging. However, as the computing technology improved the computational power of computing systems, an unauthorized party could gain the ability to identify the correct passphrase by trying every possible passphrases in a brute force manner. This rendered the passphrase based encryption mechanism vulnerable to third party security breaches.

Deficiencies of a passphrase based encryption mechanism could be addressed through passphrase enhancement. A passphrase enhancement relates to improving an original passphrase so that the enhanced passphrase is harder to identify in a brute force approach. For example, when a user provides a passphrase to a computing system, the computing system modifies the passphrase such that the modified passphrase is more complex than the original passphrase. Subsequently, the computing system would use the modified passphrase to encrypt and decrypt files. Because the passphrases can be enhanced behind the scenes, the passphrase enhancement can be transparent at least to authorized users.

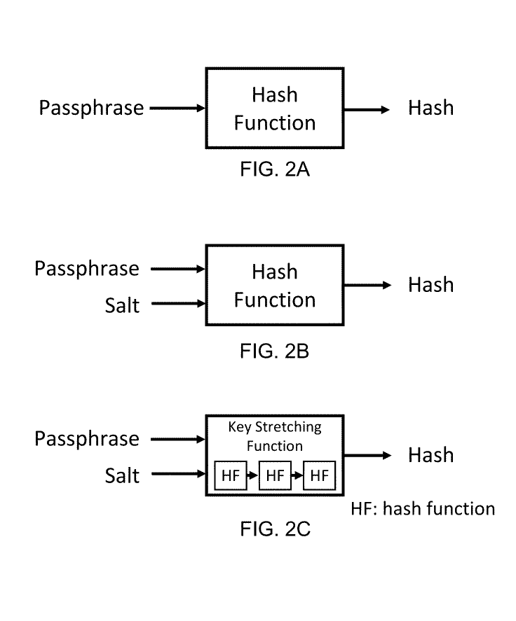

In some embodiments, a passphrase can be enhanced using a hash function. As illustrated in FIG. 2A in accordance with certain embodiments, a hash function is a routine that maps a variable length input to a fixed length output. Examples of a hash function can include a MD2 Message-Digest Algorithm, a MD5 Message-Digest Algorithm, and a Secure Hash Algorithm. In a hash-based passphrase enhancement, the input to the hash function can be the passphrase and the output of the hash function can be the enhanced passphrase:

enhanced passphrase=hash(passphrase)

Because the enhanced passphrase can be significantly more complicated than the original passphrase, it can be challenging for a third party to identify the enhanced passphrase in a brute force approach. In most cases, the only reasonable way to breach the encryption mechanism with an enhanced passphrase is to identify the original passphrase and its hash function.

In some embodiments, the hash-based passphrase enhancement can be further enhanced using a salt. A salt is a set of random bits that forms one of the inputs to the hash function, as illustrated in FIG. 2B in accordance with certain embodiments. Using a salted passphrase, the enhanced passphrase (i.e., key) depends on at least three variables: the original passphrase, the salt, and the hash function:

enhanced passphrase=hash(passphrase+salt)

Again, because the enhanced passphrase can be much more complicated than the original passphrase, the only reasonable way to breach this encryption mechanism is to identify the original passphrase, the salt, and the hash function. Since the salt needs to be identified in addition to the original passphrase and the hash function, the salt further complicates a third party's attempt to breach the encryption mechanism in a brute force approach.

Breaching a hash-based encryption mechanism in a brute force manner is challenging because there are many candidate passphrases, salt, and hash functions. Therefore, the trial-and-error approach to identifying the correct passphrase, salt, and hash function can consume a large amount of time. However, in some cases, the amount of time for the trial-and-error could be reduced through pre-computation, rendering the encryption mechanism vulnerable.

If a third party is aware of the hash function and/or the salt used in the encryption mechanism, the third party can pre-compute enhanced passphrases associated with certain candidate passphrases. The third party can then store the pre-computed passphrases in a table called a rainbow table. This way, the third party can maintain a subset of enhanced passphrases in the rainbow table.

A third party can leverage this rainbow table to determine the passphrase associated with an encrypted file. When a third party tries to breach an encrypted file, the third party can simply try the enhanced passphrases in the rainbow table until the encrypted file is decrypted. If the third party maintains enough pre-computed enhanced passphrases in the rainbow table, the third party can breach the encrypted files. Because this process only involves looking up the rainbow table and decrypting the encrypted file, this process can be quick and can be independent of the complexity of the hash function and the salt. Therefore, a rainbow table can render encryption mechanisms vulnerable to third party attacks.

One mechanism to thwart the generation of a rainbow table is key stretching. Key stretching is a mechanism that increases the time to compute a hash (e.g., an enhanced passphrase) from a key (e.g., a passphrase). Key stretching is useful for preventing brute force attacks or preventing the generation of rainbow tables because key stretching increases the required amount of time to perform the brute force attacks or to generate rainbow tables.

Key stretching can involve applying a key stretching module to a key (e.g., a passphrase.) The key stretching module can be subjected to two design criteria. The first design criteria is the computation time. The computation time of the key stretching module should be long enough so that a third party cannot compute the key stretching module numerous times to find the correct passphrase. At the same time, the computation time of the key stretching module should not be so excessive such that the computation delay is noticeable to users. In some embodiments, the computation time of the key stretching module is designed to be about one second. The second design criteria is the prevention of shortcuts. The key stretching module should not allow any shortcuts that could compute the hash in less time than the key stretching module.

In some embodiments, a key stretching module can include multiple concatenated hash functions. For example, as illustrated in FIG. 2C in accordance with certain embodiments, computing a key stretching module can include computing a single hash function a predetermined number of times. In some embodiments, the key stretching module is fixed and cannot be changed within a particular computing system. One way to do so is to fix the predetermined number of iterations, also called the iteration count. For example, the iteration count for iOS 3 is 2,000; the iteration count for iOS 4 is 10,000; the iteration count for Wi-Fi Protected Access (WPA) 2 is 4,096; and the iteration count for BlackBerry OS has been one until a recent update.

Unfortunately, the fixed iteration count can pose security threats. Because the iteration count is identical on all the machines running the same computing platform, a third party can generate a single rainbow table to access all the data in all the machines running the same computing platform. For example, if a third party would like to access multiple encrypted files on iOS 3, the third party can generate a single rainbow table using the iteration count 2,000, and use the same rainbow table to quickly identify the passphrase for all encrypted files on iOS 3. Because a single rainbow table could be used to breach many files, a third party has enough motivation to generate the rainbow table, even if that takes a long time due to key stretching. Therefore, there is a need to further improve the key stretching mechanism.

Certain embodiments of the present disclosure relate to dynamic key stretching. Dynamic key stretching is a mechanism for varying the iteration count of a key stretching module. Varying the iteration count of a key stretching module can address deficiencies associated with the traditional key stretching. For example, varying the iteration count of a key stretching module can provide a protection against rainbow tables. A rainbow table is tailored to a particular iteration count. Therefore a single rainbow table cannot be used to breach two files associated with two different iteration counts. If two files are encrypted using key stretching modules of different iteration counts, a third party cannot use a single rainbow table to breach both files.

Because a single rainbow table cannot be used, a third party attempting to breach an encryption mechanism with dynamic key stretching can only resort to one of two methods, neither of which is appealing. In the first method, the third party can maintain and use multiple rainbow tables, each of which is tailored to one of different candidate iteration counts. This method is not appealing because rainbow tables are often extremely large and consume a lot of data storage space. In the second method, the third party can determine the iteration count associated with an encrypted file and subsequently generate a rainbow table for the determined iteration count. This method is also not appealing because the rainbow table needs to be generated on-the-fly, which can incur a lot of computation time and overhead. Therefore, varying the iteration count of a key stretching module can provide a protection against rainbow tables.

Varying the iteration count of a key stretching module can also prevent the degradation of a key stretching module due to increased computational power. Computational power is an important factor in key stretching because the benefit of key stretching is predicated on the processing delay incurred by the key stretching module. Moore's Law predicts that the number of transistors on a chip, therefore the computational power of a chip, roughly doubles every 18 months. The improvement of computational power can correspondingly reduce the computational delay incurred by the key stretching module. Therefore, a key stretching module that is effective today may not be as effective a year later.

Varying the iteration count of a key stretching module addresses this issue. For example, the iteration count of a key stretching module can be increased over time so that the computation time of the key stretching module stays roughly the same over time. In other words, the increase in iteration counts can account for technological advancements by incurring further computational delays.

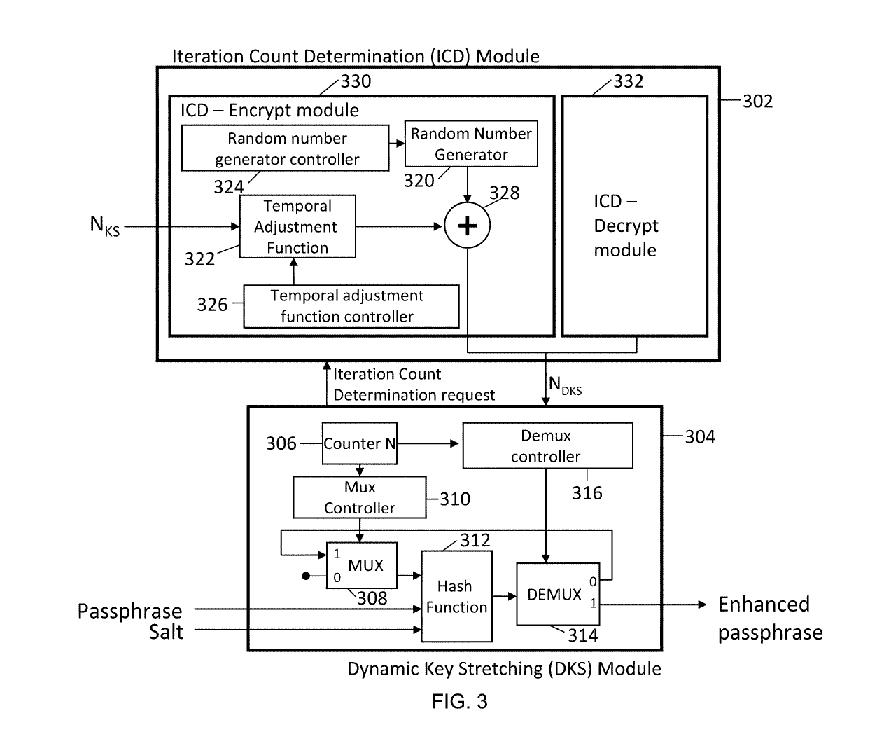

Dynamic key stretching can be implemented using an iteration count determination (ICD) module and a dynamic key stretching (DKS) module. FIG. 3 illustrates the ICD module and the DKS module in accordance with certain embodiments of the disclosed subject matter. The ICD module 302 is configured to determine the iteration count associated with a file, and the DKS module 304 is configured to use the determined iteration count to enhance the passphrase for the file. The DKS module 304 can iteratively operate a hash function on the passphrase. In some embodiments, the DKS module 304 can perform the following method:

key=hash(passphrase+salt);

for N=1 to N_{DKS}−1:

key=hash(key+passphrase+salt);

enhanced passphrase=key;

where N_{DKS} is the iteration count determined by the ICD module 302. The DKS module 304 can iteratively compute the hash of (1) the original passphrase, (2) the hash of the passphrase from the previous iteration, and (3) the salt.

The DKS module 304 can include a counter 306, a multiplexer 308, a multiplexer controller 310, a hash function 312, a demultiplexer 314, and a demultiplexer controller 316. The counter 306 maintains the number of times the passphrase has been enhanced by the hash function 312. Upon receiving the iteration count from the ICD module 302, the DKS module 304 resets the counter 306 to 0 and initiates the passphrase enhancement. When the counter value is 0, the multiplexer controller 310 outputs a value 0. When the multiplexer 308 receives 0, the multiplexer 308 couples its input port “0,” which is floating, to an output. In this case, the hash function 312 simply computes the hash of the passphrase and the salt, and provides the output to the demultiplexer 314. Subsequently, the counter 306 increases its value by 1.

When the counter value is less than the iteration count N_{DKS} received from the ICD module 302, the demultiplexer controller 316 outputs a value 0. Since the counter value is 1, the demultiplexer controller 316 provides a value 0 to the demultiplexer 314, and therefore, the demultiplexer 314 couples the output of the hash function 312 to an output port “0.” The output port “0” is coupled to the input port “0” of the multiplexer 308.

Since the counter value is 1, the multiplexer controller 310 provides a value 1 to the multiplexer 308. Therefore, the multiplexer 308 couples its input port “1,” which is the output of the hash function 312, to the input of the hash function 312. The hash function 312 subsequently computes the a hash of the three input variables: the output of the hash function from the previous iteration, the passphrase, and the salt. This process is iterated N_{DKS} times. After N_{DKS} iterations, the demultiplexer 314 provides the hash function output as the enhanced passphrase.

In some embodiments, the DKS module 304 can perform the following method:

key=hash(passphrase+salt);

for N=1 to N_{DKS}−1:

key=hash(key+salt);

enhanced passphrase=key;

In such embodiments, the DKS module 304 iteratively computes the hash of (1) the hash of the passphrase from the previous iteration and (2) the salt. One of ordinary skill in the art can modify the structure of the DKS module 304 disclosed in FIG. 3 to perform the above method.

In certain embodiments, the DKS module 304 can perform the following process:

key=hash(passphrase);

for N=1 to N_{DKS}−1:

key=hash(key);

enhanced passphrase=key;

In such embodiments, the DKS module 304 iteratively computes the hash of the hash of the passphrase from the previous iteration. One of ordinary skill in the art can modify the structure of the DKS module 304 disclosed in FIG. 3 to perform the above method.

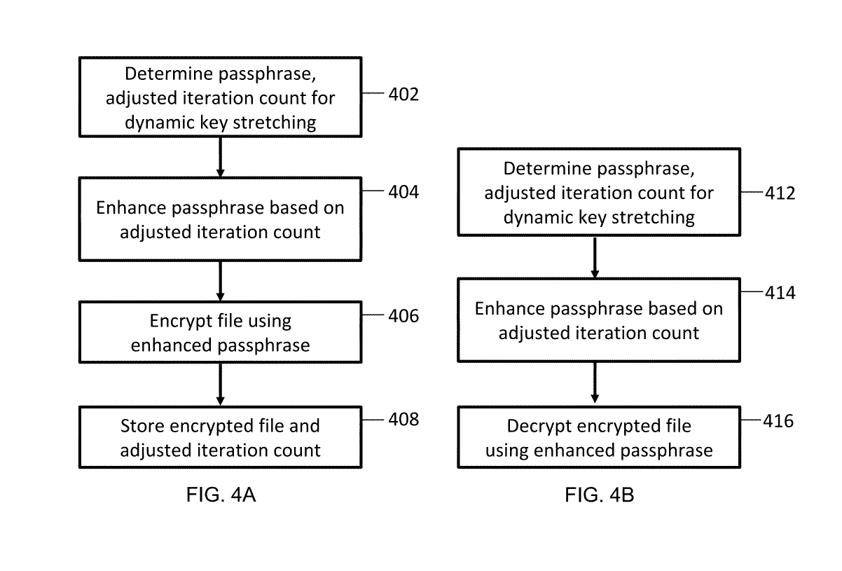

FIG. 4A illustrates how an encryption module cooperates with the ICD module 302 and the DKS module 304 to encrypt a file in accordance with certain embodiments of the disclosed subject matter. In step 402, the DKS module 304 receives the passphrase associated with the file. The DKS module 304 can also send an iteration count determination request to the ICD module 302. The iteration count determination request can include an encryption identifier, indicating that the passphrase enhancement is for encryption. Upon receiving the request, the ICD module 302 can determine the adjusted iteration count for the received passphrase. The ICD module 302 can determine the iteration count using one of at least two adjustment methods: a random adjustment method and a temporal adjustment method, as described below in more detail. In step 404, the DKS module 304 generates an enhanced passphrase, as illustrated in FIG. 3 in accordance with certain embodiments. In step 406, the encryption module receives the enhanced passphrase from the DKS module 304 and uses the enhanced passphrase to encrypt the file. In step 408, the encryption module can store the encrypted file in a physical storage medium and store the adjusted iteration count. In one embodiment, the adjusted iteration count is stored in the encrypted file's header. In other embodiments, the adjusted iteration count is stored in a database or a separate file.

FIG. 4B illustrates how a decryption module cooperates with the ICD module 302 and the DKS module 304 to decrypt an encrypted file in accordance with certain embodiments of the disclosed subject matter. In step 412, the DKS module 304 receives the passphrase associated with the file. The DKS module 304 can also send an iteration count determination request to the ICD module 302. The iteration count determination request can include a decryption identifier, indicating that the passphrase enhancement is for decryption. Upon receiving the request, the ICD module 302 can determine the adjusted iteration count for decrypting the encrypted file. In some embodiments, the ICD module 302 can determine the adjusted iteration count by retrieving it from the encrypted file's header. In other embodiments, the ICD module 302 can determine the adjusted iteration count by retrieving it from the database or the separate file maintaining the adjusted iteration count. In step 414, the DKS module 304 generates an enhanced passphrase, as illustrated in FIG. 3. In step 416, the decryption module receives the enhanced passphrase from the DKS module 304 and uses the enhanced passphrase to decrypt the encrypted file.

In certain embodiments, the ICD module 302 and the DKS module 304 can reside in a single computing system. In some embodiments, the ICD module 302 can reside in a remote server 104, and the DKS module 304 can reside in a client 106. In other embodiments, the ICD module 302 can reside in a client 106, and the DKS module 304 can reside in a server 104. If the ICD module 302 and the DKS module 304 reside in different computing systems, the ICD module 302 can communicate with the DKS module 304 via a communication network 102.

In certain embodiments, the encryption module and the decryption module can reside in a single computing system. In other embodiments, the encryption module and the decryption module can reside in different computing systems. For example, the encryption module can reside in a server 104 and the decryption module can reside in a client 106.

As discussed above, the ICD module 302 can determine the adjusted iteration count using one of at least two adjustment methods: a random adjustment method and a temporal adjustment method. The random adjustment of iteration count modifies the base (fixed) iteration count by a random number. For example, in the iOS 3 platform, the random adjustment of iteration count can adjust the base iteration count of 2,000 by a random number, such as one. More rigorously, if the base iteration count is N_{KS}, the randomly adjusted iteration count N_{DKS-R} can be computed as follows:

N_{DKS-R}=N_{KS}+R(Δ×U)

where U is a random value between −1 and 1, Δ is the maximum allowable deviation from N_{KS}, and R(•) is a round-up function. In some embodiments, the random value U can be generated using a pseudo-random generator. In other embodiments, Δ can be less than or equal to 1% of N_{KS}.

The iteration count can be varied at different abstraction levels. For example, if a computing system has multiple file systems, files in different file systems can use different iteration counts, but the files in the same file system can use the same iteration count. In another example, if a file system has multiple folders, files in different folders can use different iteration counts, but the files in the same folder can use the same iteration count. In yet another example, all the files in the file system can use different iteration counts.

In some embodiments, the ICD module 302 can also determine the adjusted iteration count using a temporal adjustment method. The temporal adjustment method is especially useful to account for computational power improvements over time. The temporal adjustment method adjusts the iteration count as a function of time. By adjusting the iteration count as a function of time, the processing time consumed by the key stretching module can remain roughly the same over time. In some embodiments, the temporal adjustment of iteration counts can be deterministic (or predictive.) For example, the iteration count N_{DKS-T} can be deterministically adjusted as an exponential function. For instance,

$${N}_{DKS - T} ( d ) = {N}_{ks} {2}^{\frac{1}{3 / 2} \times \frac{d}{365.25}}$$

where d is the number of days from a reference point in time and N_{KS} is the iteration count at that reference point in time (i.e., d=0). This way, the adjusted iteration count N_{DKS-T} grows proportionally to the growth of computing power predicted by Moore's law. In another example, the iteration count N_{DKS-T} can be adjusted as a linear function of time. For instance,

$${N}_{DKS - T} ( d ) = {N}_{0} \times ( 1 + \frac{d}{( 3 / 2 ) \times 365.25} )$$

In other embodiments, the temporal adjustment of iteration counts can be random. For example, the iteration count N_{DKS-T} can be randomly adjusted as follows:

$${N}_{DKS - T} ( d ) = {N}_{ks} {2}^{\frac{1}{3 / 2} \times \frac{d}{365.25}} + R ( Δ \times U )$$

where U is a random value between −1 and 1, Δ is the maximum allowable deviation from N_{KS}, and R(•) is a round-up function. This way, the adjusted iteration count N_{DKS-T} grows proportionally to the growth of computing power predicted by Moore's law, and can retain the benefit of randomly adjusted iteration counts. In another example, the iteration count N_{DKS-T} can be adjusted randomly as follows:

$${N}_{DKS - T} ( d ) = {N}_{0} \times ( 1 + \frac{d}{( 3 / 2 ) \times 365.25} ) + R ( Δ \times U )$$

In certain embodiments, the ICD module 302 can be implemented as illustrated in FIG. 3 in accordance with certain embodiments. The ICD module 302 can include an ICD-Encrypt module 330 and a ICD-Decrypt module 332. The ICD module 302 can use the ICD-Decrypt module 332 when the adjusted iteration count is to be used to enhance a passphrase for data decryption. In some embodiments, the ICD-Decrypt module 332 can determine the adjusted iteration count by retrieving it from the encrypted file's header. In other embodiments, the ICD-Decrypt module 332 can determine the adjusted iteration count by retrieving it from the database or the separate file maintaining the adjusted iteration count.

The ICD module 302 can use the ICD-Encrypt module 330 when the adjusted iteration count is to be used to enhance a passphrase for data encryption. In this case, the data is not associated with any adjusted iteration count, thus the adjusted iteration count cannot be retrieved. Therefore, the ICD-Encrypt module 330 computes the adjusted iteration count from a fixed iteration count N_{KS}. To compute the adjusted iteration count, the ICD-Encrypt module 330 receives a fixed iteration count N_{KS} and modify the fixed iteration count to generate the adjusted iteration count N_{DKS}. The ICD-Encrypt module 330 includes a random number generator 320, a temporal adjustment function 322, a random number generator controller 324, a temporal adjustment function controller 326, and a summation block 328. The random number generator 320 outputs either a value “0” or a random value, depending on whether the random number adjustment is turned “on” or not. The temporal adjustment function 322 receives the fixed iteration count N_{KS}, and outputs either the fixed iteration count N_{KS} or a temporally adjusted iteration count N_{DKS-T}, depending on whether the temporal adjustment is turned “on” or not.

The ICD-Encrypt module 330 receives an adjustment configuration indicating whether the ICD-Encryption module 330 should use a random adjustment method, a temporal adjustment method, or both. When the random adjustment is “off,” then the random number generator controller 324 outputs a value “0”, which turns off the random number generator 320. When the random number generator is turned off, the output of the random number generator 320 is 0. When the random adjustment is “on,” then the random number generator controller 324 outputs a value “1”, which turns on the random number generator 320. When the random number generator 320 is on, the output of the random number generator 320 is a random value sampled from a random distribution. The random distribution can be a Uniform distribution, a Gaussian distribution, a Log-normal distribution, a Pareto distribution, a Binomial distribution, a Bernoulli distribution, a Poisson distribution, or any other suitable distribution.

When the temporal adjustment is “off,” the temporal adjustment function controller 326 outputs a value “0,” which turns off the temporal adjustment function 322. When the temporal adjustment function 322 is turn off, the output of the temporal adjustment function 322 is the same as its input: the fixed iteration count N_{KS}. When the temporal adjustment is “on,” the temporal adjustment function controller 326 outputs a value “1,” which turns on the temporal adjustment function 322. When the temporal adjustment function 322 is turn on, the output of the temporal adjustment function 322 is the temporally adjusted iteration count, adjusted using the method disclosed above.

The output of the random generator 320 and the temporal adjustment function 322 are summed at the summation block 328. The summation block 328 adds the output of the random number generator 320 and the temporal adjustment function 322 to provide the adjusted iteration count N_{DKS}. As disclosed above, the adjusted iteration count can be computed based on the random adjustment method, the temporal adjustment method, or both.

Key stretching is predicated on an assumption that different computing systems have similar computing power. Any significant difference in computing power may pose problems in key stretching because a third party can quickly generate rainbow tables for a slow computing system using a fast, powerful computing system. Unfortunately, a significant difference in computing power does exist across different computing systems. For example, a server in a data center is significantly more powerful than a mobile device. Therefore, if key stretching is targeted at a range of computing devices, key stretching may not be as effective.

Computing power variations across different computing systems can be addressed using offloaded key stretching, in accordance with certain embodiments. Offloaded key stretching relates to offloading the computation of a key stretching module to a more powerful system, such as a server. For example, a mobile device can offload the computation of a key stretching module to a server. This way, the mobile device can use a complex key stretching module that would also incur a substantial delay to powerful computing systems, even if the mobile device has limited computing power.

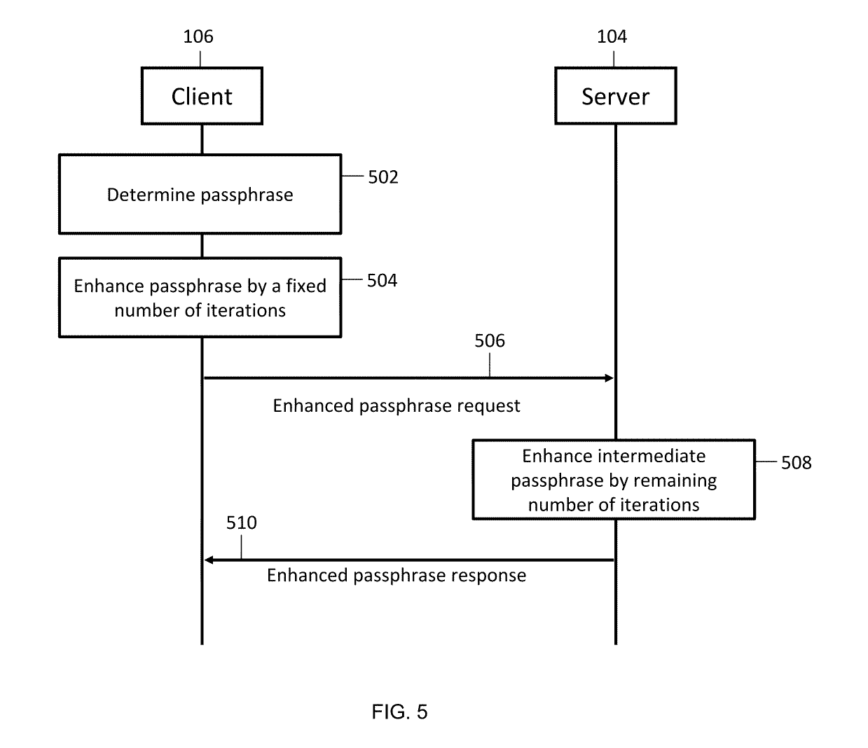

FIG. 5 illustrates off-loaded key stretching in accordance with certain embodiments of the disclosed subject matter. In FIG. 5, a client 106 is configured to enhance a passphrase by a iteration count. At a high level, the client 106 enhances the passphrase to an intermediate passphrase by applying a hash function to the passphrase a predetermined number of times, as in traditional key stretching. Then, the client 106 provides the intermediate passphrase to the server 104 and indicates how many times the hash function has been applied to the passphrase. Subsequently, the server 104 picks up on where the client 106 had left off, and enhances the intermediate passphrase to the enhanced passphrase.

In step 502, the client 106 receives the passphrase. In step 504, the client 106 enhances the passphrase by a predetermined number of iterations. The predetermined number of iterations is less than the iteration count for key stretching. In some embodiments, the predetermined number of iterations is significantly less than the iteration count. For example, the fixed number of iterations can be two. By the end of step 504, the client 106 would have generated an intermediate passphrase. In some embodiments, step 504 can be skipped. In this case, the predetermined number of iterations is zero, and the intermediate passphrase can be the original passphrase.

In step 506, the client 106 sends an enhanced passphrase request to a server 104. The enhanced passphrase request can include the intermediate passphrase. In some embodiments, the enhanced passphrase request can indicate the predetermined number of iterations associated with the intermediate passphrase. In other embodiments, the enhanced passphrase request can include the iteration count. In another embodiment, the enhanced passphrase request can include the remaining number of iterations for the hash function (i.e., the difference between the iteration count and the predetermined number of iterations.) In certain embodiments, the enhanced passphrase request can indicate which hash function should be used to enhance the intermediate passphrase. The client 106 and the server 104 can communicate over the communication network. The communication network can include a secure communication channel equipped with security protocols such as a Hypertext Transfer Protocol Secure (HTTPS).

In step 508, the server 104 enhances the intermediate passphrase by the remaining number of iterations (i.e., the difference between the predetermined iteration count and the fixed number of iterations associated with the intermediate passphrase.) Once the server 104 finishes the passphrase enhancement, in step 510, the server 104 can send an enhanced passphrase response to the client 106, providing the enhanced passphrase to the client 106.

Offloaded key stretching can provide many benefits to clients. For example, offloaded key stretching can be energy efficient for clients, which is an important feature for mobile devices. For clients, computing the intermediate passphrase and communicating with the server can consume substantially less energy compared to computing the enhanced passphrase on its own. This is especially true if the key stretching module is complex. Offloaded key stretching can also allow using more secure, complex key stretching modules. Even if the client's computing power is substantially less than a server, the client can still use complex key stretching modules because complex computations are offloaded to a powerful system such as a server.

In certain embodiments, offloaded key stretching can be used in conjunction with dynamic key stretching. For example, a client can include a traditional key stretching module and an iteration count determination (ICD) module, and a server can include a dynamic key stretching (DKS) module. When a client needs to compute an enhanced passphrase, the client can determine the adjusted iteration count using the ICD module, and use the procedure in FIG. 5 to generate the enhanced passphrase based on the adjusted iteration count. In another example, the client can only include a traditional key stretching module, and the server can include a DKS module and an iteration count determination (ICD) module. In this example, when a client needs to compute an enhanced passphrase, the client can generate an intermediate passphrase from the original passphrase and provide the intermediate passphrase to the server. The server would then determine the adjusted iteration count for the intermediate passphrase, enhance the intermediate passphrase, and provide the intermediate passphrase and the adjusted iteration count to the client.

In certain embodiments, parameters associated with dynamic key stretching and offloaded key stretching can be updated. For example, the base iteration count N_{KS} for dynamic key stretching can be modified upon receiving a reset request. Also, in offloaded key stretching, the fixed number of hash function iterations performed at the client can be modified upon receiving a reset request.

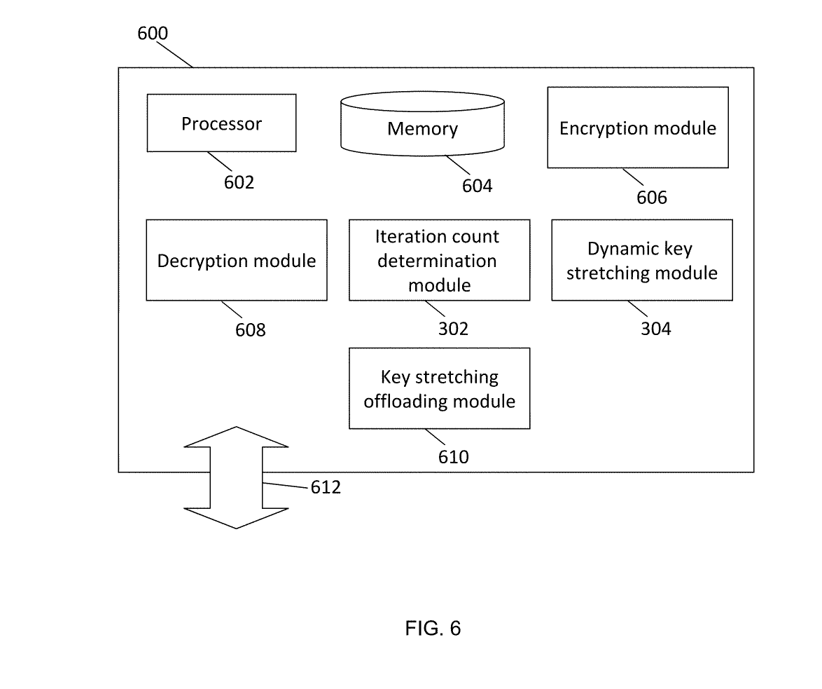

FIG. 6 illustrates a block diagram of a computing system in accordance with certain embodiments of the disclosed subject matter. The computing system 600 can include at least a processor 602, at least one memory 604, and one or more of the following: an encryption module 606, a decryption module 608, an iteration count determination (ICD) module 302, a dynamic key stretching (DKS) module 304, an key stretching offloading module 610, and an interface 612.

The encryption module 606 is configured to encrypt a file using an encryption key, and the decryption module 608 is configured to decrypt an encrypted file using a decryption key. In some embodiments, the encryption key and the decryption key can be identical. The key can be a passphrase or an enhanced passphrase. The encryption module 606 or the decryption module 608 can receive a passphrase from a user or another computing system. The encryption module 606 or the decryption module 608 can receive an enhanced passphrase from the dynamic key stretching module 304 or from another computing system.

The iteration count determination (ICD) module 302 is configured to determine an iteration count for the dynamic key stretching (DKS) module 304. The ICD module 302 can use one of at least two methods: a random adjustment method and a temporal adjustment method. The DKS module 304 is configured to use the iteration count from the ICD module 302 to enhance a passphrase to an enhanced passphrase.

The key stretching offloading module 610 is configured to offload the computation of the key stretching module to another computing system. In some embodiments, the key stretching offloading module 610 computes an intermediate passphrase and provides the intermediate passphrase to another computing system, which subsequently computes the enhanced passphrase from the intermediate passphrase.

The encryption module 606, the decryption module 608, the ICD module 302, the DKS module 304, and the key stretching offloading module 610 can be implemented in software, which may be stored in memory 604. FIGS. 3-5 show a computing system 600, such as a server 104 or a client 106, having one or more of the separate modules 606, 608, 302, 304, and 610 that perform the above-described operations in accordance with certain embodiments of the disclosed subject matter. In other embodiments of the invention, the computing system 600 can include additional modules, less modules, or any other suitable combination of modules that perform any suitable operation or combination of operations. The memory 604 can be a non-transitory computer readable medium, flash memory, a magnetic disk drive, an optical drive, a programmable read-only memory (PROM), a read-only memory (ROM), or any other memory or combination of memories. The software runs on a processor 602 capable of executing computer instructions or computer code. The processor 602 might also be implemented in hardware using an application specific integrated circuit (ASIC), programmable logic array (PLA), field programmable gate array (FPGA), or any other integrated circuit.

An interface 612 provides an input and/or output mechanism to communicate internal to, and external to, the computing system 600. The interface 612 can be implemented in hardware to send and receive signals in a variety of mediums, such as optical, copper, and wireless, and in a number of different protocols some of which may be non-transient.

The computing system 600 can be configured with one or more processors 602 that process instructions and run software that may be stored in the memory 604. The processor 602 also communicates with the memory and interfaces to communicate with other devices. The processor 602 can be any applicable processor such as a system-on-a-chip that combines a CPU, an application processor, and flash memory.

The computing system 600 can include a server 104 or a client 106. In one embodiment, a server 104 can include at least the processor 602, at least one memory 604, the interface 612, the encryption module 606, and the decryption module 608. In another embodiment, a server 104 can include at least the processor 602, at least one memory 604, the interface 612, the encryption module 606, the decryption module 608, and the ICD module 302. In yet another embodiment, a server 104 can include at least the processor 602, at least one memory 604, the interface 612, the encryption module 606, the decryption module 608, the ICD module 302, and the DKS module 304.

In one embodiment, a client 106 can include at least the processor 602, at least one memory 604, and the DKS module 304. In another embodiment, a client 106 can include at least the processor 602, at least one memory 604, the DKS module 304, and the ICD module 302. In yet another embodiment, a client 106 can include at least the processor 602, at least one memory 604, the DKS module 304, and the ICD module 302, and an key stretching offloading module 610. In yet another embodiment, a client 106 can include at least the processor 602, at least one memory 604, an encryption module 604, the DKS module 304, and the ICD module 302, and an key stretching offloading module 610. In yet another embodiment, a client 106 can include at least the processor 602, at least one memory 604, a decryption module 606, the DKS module 304, and the ICD module 302, and an key stretching offloading module 610. In yet another embodiment, a client 106 can include at least the processor 602, at least one memory 604, an encryption module 604, a decryption module 606, the DKS module 304, and the ICD module 302, and an key stretching offloading module 610.

The server 104 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 104. A task can be a software process that performs a specific function related to system control or session processing. Three types of tasks operate within the server 104 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 104 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 104 by monitoring the various software and hardware components of the server 104. Recovery control task subsystem is responsible for executing a recovery action for failures that occur in the server 104 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 104 with an ability to set, retrieve, and receive notification of server configuration parameter changes and is responsible for storing configuration data for the applications running within the server 104. A resource management subsystem is responsible for assigning resources (e.g., processor and memory capabilities) to tasks and for monitoring the task's use of the resources.

In some embodiments, the server 104 can reside in a data center and form a node in a cloud computing infrastructure. The server 104 can also provide services on demand. A module hosting a client is capable of migrating from one server to another server seamlessly, without causing program faults or system breakdown. The server 104 on the cloud can be managed using a management system.

The client 106 can include user equipment of a cellular network. The user equipment communicates with one or more radio access networks and with wired communication networks. The user equipment can be a cellular phone having phonetic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The client 106 also includes any platforms capable of computations and communication. Non-limiting examples can include televisions (TVs), video projectors, set-top boxes or set-top units, digital video recorders (DVR), computers, netbooks, laptops, and any other audio/visual equipment with computation capabilities.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. An apparatus comprising:
a processor configured to run a module stored in memory that is configured to:
receive, from a dynamic key stretching module, an iteration count determination request to provide an adjusted iteration count to the dynamic key stretching module;
determine whether the adjusted iteration count is to be used to enhance a passphrase for data encryption or data decryption;
when the adjusted iteration count is to be used to enhance the passphrase for data encryption:
compute the adjusted iteration count by modifying a base iteration count according to an adjustment configuration; and
when the adjusted iteration count is to be used to enhance the passphrase for data decryption:
retrieve, from a non-transient storage medium, the adjusted iteration count that was used to encrypt the data; and
provide the adjusted iteration count to the dynamic key stretching module.

2. The apparatus of claim 1, wherein the processor is further configured to run the dynamic key stretching module stored in the memory that is configured to:
receive the adjusted iteration count; and
operate a hash function on the passphrase by the adjusted iteration count to compute an enhanced passphrase associated with the passphrase.

3. The apparatus of claim 1, wherein the processor is further configured to run an encryption module stored in the memory that is configured to encrypt a file using the enhanced passphrase and to store the encrypted file in a non-transitory storage medium, wherein the encrypted file's header includes the adjusted iteration count.

4. The apparatus of claim 1, wherein the iteration count determination request indicates whether the adjusted iteration count is to be used for data encryption or data decryption.

5. The apparatus of claim 1, wherein the adjustment configuration indicates that the base iteration count be modified by a random number.

6. The apparatus of claim 5, wherein the random number is significantly smaller than the base iteration count.

7. The apparatus of claim 1, wherein the adjustment configuration indicates that the base iteration count be modified by a function of time.

8. The apparatus of claim 7, wherein the function of time comprises an exponential function of time.

9. The apparatus of claim 1, further comprising one or more interfaces configured to provide communication with a server via a communication network, wherein the dynamic key stretching module is configured to run on the server, and wherein the module is configured to provide the adjusted iteration count to the dynamic stretching module using the one or more interfaces via the communication network.

10. The apparatus of claim 9, wherein the module is configured to receive the iteration count determination request from the dynamic key stretching module on the server via the communication network.

11. The apparatus of claim 1, wherein the module is configured to update the base iteration count upon receiving a reset request.

12. A method comprising:
receiving, from a dynamic key stretching module, an iteration count determination request, requesting the module to provide an adjusted iteration count to the dynamic key stretching module;
determining whether the adjusted iteration count is to be used to enhance a passphrase for data encryption or data decryption;
when the adjusted iteration count is to be used to enhance the passphrase for data encryption:
computing the adjusted iteration count by modifying a base iteration count according to an adjustment configuration;
when the adjusted iteration count is to be used to enhance the passphrase for data decryption:
retrieving, from a non-transient storage medium, the adjusted iteration count that was used to encrypt the data; and
providing the adjusted iteration count to the dynamic key stretching module.

13. The method of claim 12, further comprising:
receiving the adjusted iteration count;
operating a hash function on the passphrase by the adjusted iteration count to compute an enhanced passphrase associated with the passphrase;
encrypting a file using the enhanced passphrase; and
storing the encrypted file in a non-tangible storage medium, wherein the encrypted file's header includes the adjusted iteration count.

14. The method of claim 12, wherein the adjustment configuration indicates that the base iteration count be modified by a random number.

15. The method of claim 12, wherein the adjustment configuration indicates that the base iteration count be modified by a function of time.

16. A non-transitory computer readable medium having executable instructions operable to cause an apparatus to:
receive, from a dynamic key stretching module, an iteration count determination request, requesting the module to provide an adjusted iteration count to the dynamic key stretching module;
determine whether the adjusted iteration count is to be used to enhance a passphrase for data encryption or data decryption;
when the adjusted iteration count is to be used to enhance the passphrase for data encryption:
compute the adjusted iteration count by modifying a base iteration count according to an adjustment configuration;
when the adjusted iteration count is to be used to enhance the passphrase for data decryption:
retrieve, from a non-transient storage medium, the adjusted iteration count that was used to encrypt the data; and
provide the adjusted iteration count to the dynamic key stretching module.

17. The computer readable medium of claim 16, wherein the adjustment configuration indicates that the base iteration count be modified by a random number.

18. The computer readable medium of claim 16, wherein the adjustment configuration indicates that the base iteration count be modified by a function of time.

19. The computer readable medium of claim 18, wherein the function of time comprises an exponential function of time.

20. The computer readable medium of claim 16, further comprising executable instructions operable to cause the apparatus to update the base iteration count upon receiving a reset request.
